(19) United States
(12) Patent Application Publication
(10) Pub. No.: US 2018/0206311 A1
(43) Pub. Date: Jul. 19, 2018

(54) COOKING APPLIANCE AND METHODS OF OPERATION

(71) Applicant: Haier US Appliance Solutions, Inc., Wilmington, DE (US)

(72) Inventors: John Adam Yantis, Prospect, KY (US); Craig E. Wicke, Louisville, KY (US)

(21) Appl. No.: 15/406,834

(22) Filed: Jan. 16, 2017

(51) Int. Cl. H05B 37/02; H05B 33/08; G06F 3/044; F24C 15/02; F24C 15/18

(52) U.S. Cl. CPC H05B 37/0227; H05B 37/0281; H05B 37/0218; F24C 15/18; G06F 3/044; F24C 15/028; H05B 33/0842

(57) ABSTRACT

A cooking appliance and method of operation is provided herein. The cooking appliance may include a cabinet housing, an interface panel, a lighting device, and a controller. The interface panel may be mounted to the cabinet housing and include a user input. The lighting device may be positioned on the cabinet housing above the interface panel. The lighting device may be directed toward the user inputs. The controller attached to the cabinet housing in operable communication with the lighting device, the controller being configured to energize the lighting device according to a lighting task. The lighting task may include receiving a provisional lighting command, determining an activation condition subsequent to receiving the provisional lighting command, and activating the lighting device in response to the determination of the activation condition.

### FIELD OF THE INVENTION

The present subject matter relates generally to cooking appliances, and more particularly to cooking appliances having one or more lighting features for illumination.

### BACKGROUND OF THE INVENTION

Cooking appliances, such as cooktops or range appliances, generally include a burner or heat source positioned on a portion of a cabinet or support panel. Cooking appliance can include a variety of configurations for the heating sources located on a top surface. The number of heating sources or positions available for heating on the cooktop can include e.g., four, six, or more depending upon the intended application and preferences of the buyer. These heating sources can vary in size and location along the surface of the cooking appliance.

Regardless of the heating source configuration, it may desirable to provide light or illumination for certain portions of the cooking appliance. For instance, it may be desirable to illuminate a region below the heating sources. Some systems may have a control panel extending along a front portion of the cooking appliance below the heating sources. In order to read the control panel and/or ensure proper operation, it may generally necessary to illuminate the control panel. However, low-light conditions may make this exceedingly difficult. Moreover, objects such as ventilation hoods and/or cabinets may block much of the light that would otherwise illuminate such a control panel.

Some systems may include a lighting device with a corresponding switch on or adjacent to the front panel of the appliance. However, placing a switch on or adjacent to the front panel may create a cluttered appearance. It is also possible that the switch may be difficult to reach under certain conditions. A simple switch may be unresponsive to certain conditions and require direct user input to turn the lighting device on/off.

As a result, it may be desirable to provide an oven appliance wherein a region below one or more heating sources may be illuminated. Moreover, it may be further desirable to provide one or more methods or features for illuminating the oven appliance automatically, without direct user input, in response to certain predetermined conditions.

### BRIEF DESCRIPTION OF THE INVENTION

Aspects and advantages of the invention will be set forth in part in the following description, or may be obvious from the description, or may be learned through practice of the invention.

In one aspect of the present disclosure, a method for illuminating a cooking appliance is provided. The method may include receiving a provisional lighting command, determining an activation condition subsequent to receiving the provisional lighting command, and activating a lighting device in response to the determination of the activation condition.

In another aspect of the present disclosure, a cooking appliance is provided. The cooking appliance may include a cabinet housing, an interface panel, a lighting device, and a controller. The interface panel may be mounted to the cabinet housing and include a user input. The lighting device may be positioned on the cabinet housing above the interface panel. The lighting device may be directed toward the user inputs. The controller attached to the cabinet housing in operable communication with the lighting device, the controller being configured to energize the lighting device according to a lighting task. The lighting task may include receiving a provisional lighting command, determining an activation condition subsequent to receiving the provisional lighting command, and activating the lighting device in response to the determination of the activation condition

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a cooking according to example embodiments of the present disclosure.

FIG. 2 provides a side view of the example cooking appliance of FIG. 1.

FIG. 3 provides a perspective view of a control panel portion of the example cooking appliance of FIG. 1.

FIG. 4 provides a cross-sectional schematic view of the example control panel of FIG. 3.

FIG. 5 provides a flow chart illustrating an example method of operating a cooking appliance.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

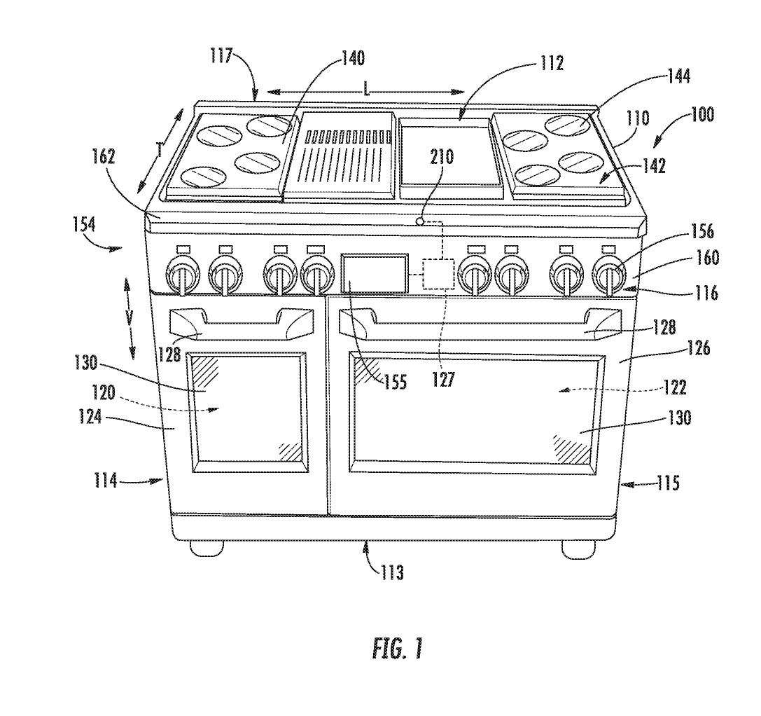

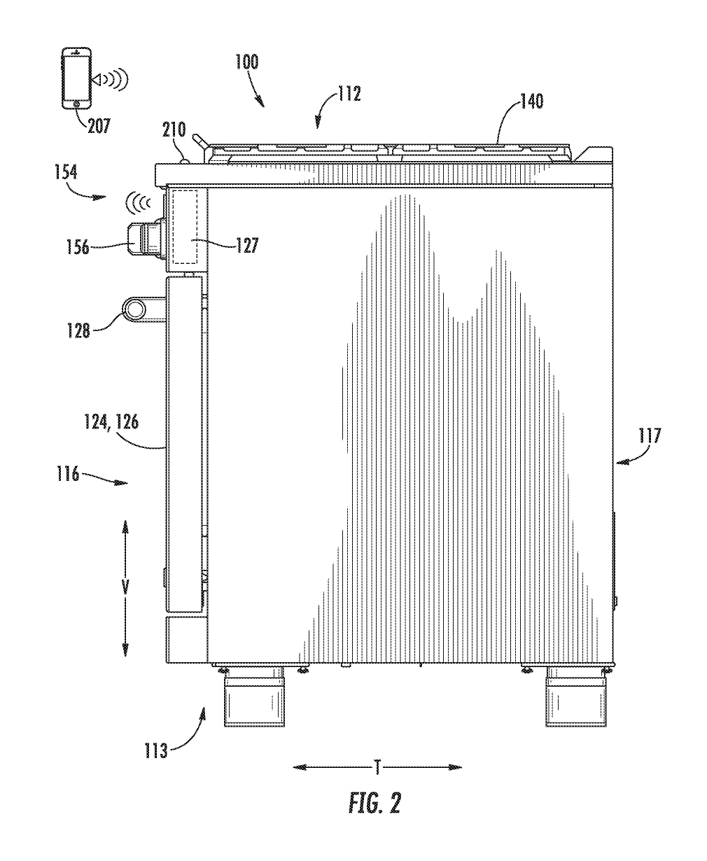

FIG. 1 provides a front, perspective view of a cooking appliance 100 as may be employed with the present disclosure. FIG. 2 provides a side view of cooking appliance 100. Cooking appliance 100 includes an insulated cabinet housing or cabinet 110. As shown, cooking appliance 100 defines a vertical direction V, a lateral direction L, and a transverse direction T, e.g., at cabinet 110. The vertical direction V, lateral direction L, and transverse direction T are mutually perpendicular and form an orthogonal direction system.

As shown, cabinet 110 extends along the vertical direction V between a top portion 112 and a bottom portion 113; along the lateral direction L between a left side portion 114 and a right side portion 115; and along the traverse direction T between a front portion 116 and a rear portion 117. Moreover, cabinet 110 defines a left cooking chamber 120 and a right cooking chamber 122. Thus, cooking appliance 100 is generally referred to as a double oven range appliance. As will be understood by those skilled in the art, cooking appliance 100 is provided by way of example only, and the present subject matter may be used in any suitable appliance, e.g., a single oven range appliance or a standalone cooktop appliance. Thus, the example embodiments illustrated in FIGS. 1 and 2 are not intended to limit the present disclosure matter to any particular cooking chamber configuration or arrangement, except as otherwise indicated.

Left and right cooking chambers 120 and 122 are configured for the receipt of one or more food items to be cooked. Cooking appliance 100 includes a left door 124 and a right door 126 rotatably attached to cabinet 110 in order to permit selective access to left cooking chamber 120 and right cooking chamber 122, respectively. Handles 128 are mounted to left and right doors 124 and 126 to assist a user with opening and closing doors 124 and 126 in order to access cooking chambers 120 and 122. As an example, a user can pull on the handle 128 mounted to left door 124 to open or close left door 124 and access left cooking chamber 120. Glass window panes 130 provide for viewing the contents of left and right cooking chambers 120 and 122 when doors 124 and 126 are closed and also assist with insulating the cooking chambers 120 and 122. Heating elements (not shown), such as electric resistance heating elements, gas burners, microwave heating elements, halogen heating elements, or suitable combinations thereof, are positioned within left cooking chamber 120 and right cooking chamber 122 for heating left cooking chamber 120 and right cooking chamber 122.

Cooking appliance 100 also includes a cooktop 140. Cooktop 140 is positioned at or adjacent a top portion of cabinet 110. Thus, cooktop 140 is positioned above left and right cooking chambers 120 and 122. Cooktop 140 includes a top panel 142. By way of example, top panel 142 may be constructed of glass, ceramics, enameled steel, and combinations thereof.

For cooking appliance 100, a utensil (not pictured) holding food and/or cooking liquids (e.g., oil, water, etc.) may be placed onto one or more of burner assemblies 144, e.g., on a cooking grate (not pictured). Burner assemblies 144 provide thermal energy to cooking utensils thereon. As shown in FIG. 1, burners assemblies 144 can be configured in various sizes so as to provide e.g., for the receipt of cooking utensils (e.g., pots, pans, etc.) of various sizes and configurations and to provide different heat inputs for such cooking utensils.

In some embodiments, user interface or control panel 154 is located within convenient reach of a user of the cooking appliance 100. For some example embodiments, user interface panel 154 includes a front panel 160 disposed on the front portion 116 of cabinet 110. As shown, front panel 160 may be mounted to cabinet 110. Moreover, user interface panel 154 may include one or more knobs 156 that are each associated with one of burner assemblies 144. Knobs 156 allow the user to activate each burner assembly and determine the amount of heat input provided by each burner assembly 144 to a cooking utensil located thereon. User interface panel 154 may also be provided with one or more graphical displays 155 that deliver certain information to the user such as e.g., whether a particular burner assembly is activated and/or the rate at which the burner assembly is set.

Although shown with knobs 156, it should be understood that knobs 156 and the configuration of cooking appliance 100 shown in FIG. 1 is provided by way of example only. More specifically, user interface panel 154 may include various input components, such as one or more of a variety of touch-type controls, electrical, mechanical or electro-mechanical input devices including rotary dials, push buttons, and touch pads. Optionally, the graphical display 155 may be provided as a touch screen interface configured to receive input commands from a user (e.g., via a capacitive touch panel). Moreover, the user interface panel 154 may include other display components, such as a digital or analog display device designed to provide operational feedback to a user.

As shown in FIG. 1, cabinet 110 may include a protruding panel lip 162 (known as bullnose in the art) that is attached to the upper edge of the front panel 160 and extends outward therefrom. Specifically, protruding panel lip 162 may be As will be described in detail below, a lighting device 200 may be positioned on the cabinet 110, e.g., within protruding panel lip 162. Lighting device 200 may include one or more light sources that are generally directed to the user interface panel 154, e.g., downward to project light below the burner assemblies 144. In optional embodiments, each lighting device 200 may be directed toward the user inputs, e.g., knobs 156, to provide illumination at the user interface panel 154 (e.g., in response to one or more predetermined activation conditions).

Cooking appliance 100 is further equipped with a controller 127 to regulate operation of the cooking appliance 100. For example, controller 127 may regulate the operation of one or more portions of cooking appliance 100, such as the burner assemblies 144, user interface 154, and/or lighting device 200. Controller 127 may be in communication (via, for example, a suitable wired or wireless connection) with user interface 154, e.g., at graphical display 155 and/or knobs 156. Additionally or alternatively, controller may be in communication (via, for example, a suitable wired or wireless connection) with the lighting device 200 and other suitable components of the cooking appliance 100, as discussed herein. In general, controller 127 may be operable to configure the cooking appliance 100 (and various components thereof) for cooking. Such configuration may be based on a plurality of cooking factors of a selected operating cycles, sensor feedback, etc. Moreover, controller 127 may be operable to configured the cooking appliance 100 for illuminating portions of the cooking appliance 100, e.g., according to one or more predetermined lighting tasks, as will be described in detail below.

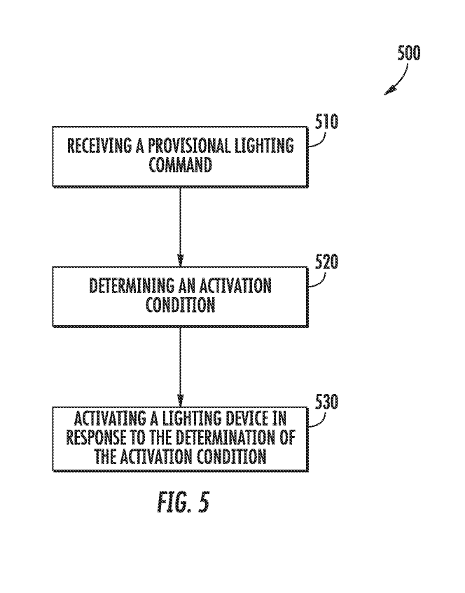

By way of example, controller 127 may include one or more memory devices 148 and one or more processors 150, such as general or special purpose microprocessors operable to execute programming instructions or micro-control code associated with an operating cycle. The memory 148 may represent random access memory such as DRAM, or read only memory such as ROM or FLASH. In one embodiment, the processor 150 executes programming instructions stored in memory 148. The memory 148 may be a separate component from the processor 150 or may be included onboard within the processor 150. The memory 148 can store information accessible to processor 150, including instructions that can be executed by processor 150. Optionally, the instructions can be software or any set of instructions that when executed by the processor 150, cause the processor 150 to perform operations. For certain embodiments, the instructions include a software package configured to operate appliance 100 and execute certain tasks (e.g., lighting tasks). For example, the instructions may include a software package configured to execute the example method 500 described below with reference to FIG. 5.

Additionally or alternatively, a clock module 152 may be included within controller 127. Clock module 152 may be configured to track changes in time, e.g., as a uniform standard time or an isolated time period. In some example embodiments, the clock module is a separate processor in operable communication (e.g., electrically coupled) with the processor 150. In other example embodiments, clock module 152 forms a portion of the processor 150 and/or memory 148.

Controller 127 may be positioned in a variety of locations throughout cooking appliance 100. As an example, one or more portions of controller 127 may be located within a user interface panel 154 of cooking appliance 100. In such an embodiment, input/output (“I/O”) signals may be routed between the control system and various operational components of cooking appliance 100 along wiring harnesses that may be routed through cabinet 110. Typically, controller 127 is in communication with user interface panel 154 through which a user may select various operational features and modes and monitor progress of cooking appliance 100. In example embodiments, user interface panel 154 may represent a general purpose I/O (“GPIO”) device or functional block.

Optional embodiments may include an auxiliary control device 207 in operable communication with controller 127. Auxiliary control device 207 may be embodied as a discrete processing unit, such as a smart phone, tablet, or laptop computer positioned apart from the cabinet 110. In some embodiments, auxiliary control device 200 is in wireless communication with controller 127. Both controller 127 and auxiliary control device 207 may share a layer protocol architecture, that is adapted for short-wavelength ultra-high frequency (UHF) communications in a band between 2.4 GHz and 2.485 GHz (e.g., according to the IEEE 802.15.1 standard). During operations, auxiliary control device 207 may receive and/or transmit data signals from controller 127 to affect and display information about the operations of the cooking appliance 100.

In further optional embodiments, one or more additional sensors 210 are provided in operable communication with controller 127 (via, for example, a suitable wired or wireless connection). For example, sensor 210 may be an ambient light sensor or a motion sensor. Sensor 210 may be configured to transmit a signal to be received by controller 127. In some embodiments, a light sensor may transmit an ambient light sensor in response to a detected decrease in ambient light. Additionally or alternatively, a motion sensor may transmit a motion signal in response to a detected movement or motion. Further additional or alternative embodiments may include one or more sensor embodiments that require no physical contact by a user, such as to a switch of the sensor 210 to operate, are within the scope and spirit of the present disclosure. As shown in FIG. 1, at least one sensor 210 may be mounted directly on or in cabinet 110. As will be described in detail below, controller 127 may subsequently activate lighting device 200 based on one or more signals received from sensor 210.

Advantageously, appliance 100 may automatically, without direct user input, activate lighting device 200 and/or deactivate lighting device 200 in response to signals received at controller 127 (e.g., signals from clock module, sensor 210, etc.).

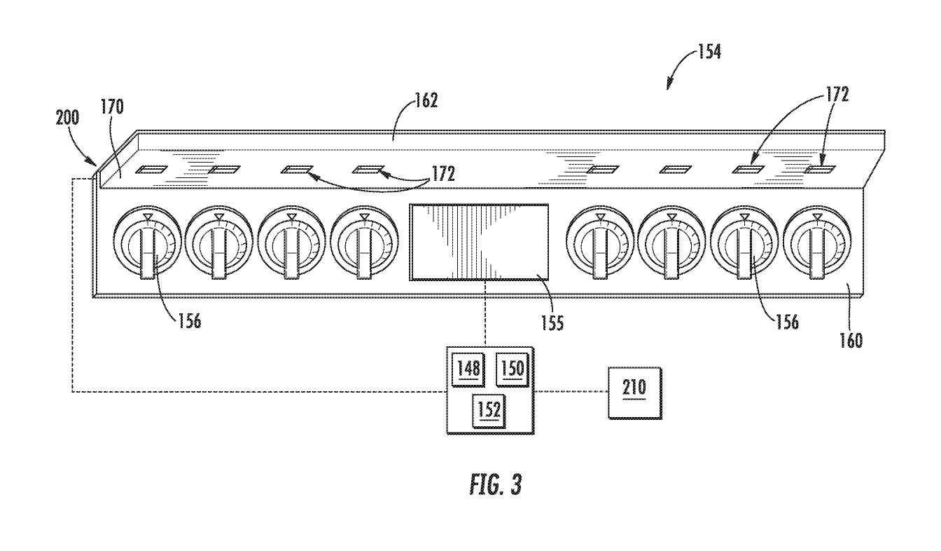

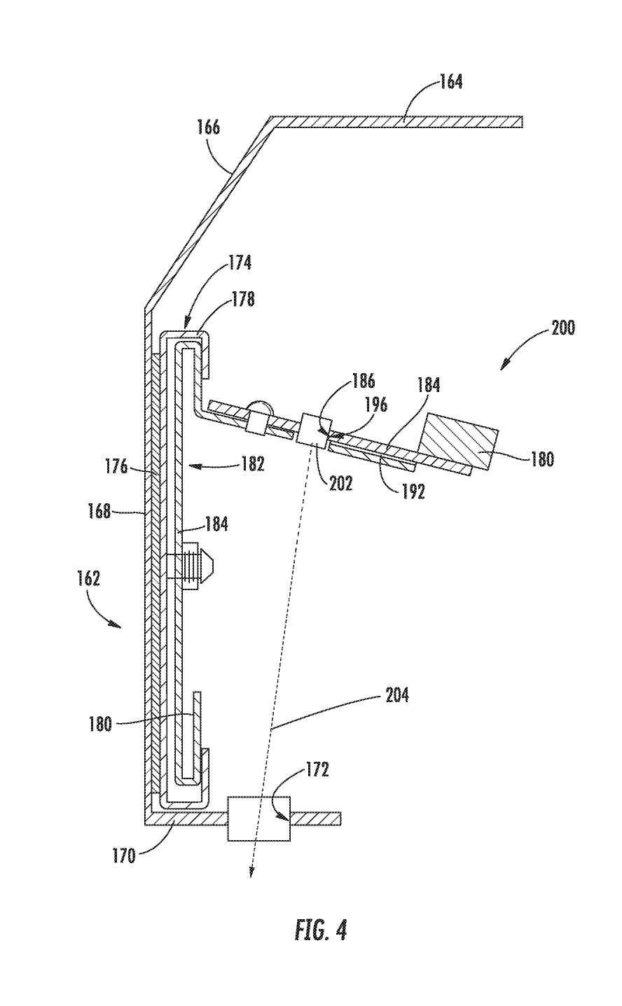

Turning now to FIGS. 3 and 4, in some embodiments, the panel lip 162 has a substantially horizontally disposed (e.g., perpendicular to the vertical direction V), upward facing top surface 164. Optionally, top surface 164 may be integral (e.g., as a single unitary member) with the cooktop 140. The panel lip 162 may include an oblique upper front surface 166 that extends outward (e.g., in the transverse direction T) and downward (e.g., in the vertical direction V) from the outer edge of the top surface 164. Moreover, panel lip 162 may include a substantially vertically disposed lower front surface 168 that extends downward from the lower edge of the upper front surface 166. The panel lip 162 may still further include a substantially horizontally disposed, downward facing bottom surface 170 that extends inward from the bottom edge of the lower front surface 168. In optional embodiments, the top surface 164, the oblique upper front surface 166, the lower front surface 168, and the bottom surface 170 are formed as an integral or one-piece element.

In some embodiments, the bottom surface 170 of the panel lip 162 has a plurality of openings or slots 172 that are disposed above, and preferably substantially aligned with the respective switch knobs 156. Lighting device 200 may be disposed inside of panel lip 162. Moreover, when assembled, lighting device 200 may be supported by the panel lip 162. As shown, a support member or rail member 174 may be releasably attached to the lower front surface 168 of the panel lip 162, e.g., by fasteners such as an adhesive tape 176. The support member 174 has an upper bent portion 178 and a lower bent portion 180.

In certain embodiments, lighting device 200 includes a mounting member 182 that is attached to the support member 174. A carrying member 184 may be releasably supported by the mounting member 182. As shown, carrying member 184 may hold a light source, such as a light emitting diode (LED) 202. In some such embodiments, the light source or LED 202 faces downward, e.g., to illuminate or direct light in that same direction. A fastener pass-through hole 186 and a connector, such as a two-pin connector 188, may be included with each LED 202. Optionally, the carrying member 184 is made of a thermally conducting material. Moreover, each mounting member 182 may include a substantially elongated first portion 190. The first portion 190 may include has an upper bent portion 179, a lower bent portion 181, and a hole such as a threaded hole 183. The first portion 190 is may be formed to compliment support member 174, e.g., such that the first portion 190 is received by, and is slidable along the support member 174.

An electrically insulating and thermally conducting member 192 may be placed on the second portion 194 of the mounting member 182. The electrically insulating and thermally conducting member 192 has a corresponding light pass-through hole 196 to permit light, e.g., from each LED 202. In some embodiments, a plurality of light sources or LEDs 202 is provided. As shown, carrying member 184 may be placed on the electrically insulating and thermally conducting member 192 with the LED(s) 202 being substantially aligned with and disposed in the aligned light pass-through holes 196. Each LED 202 may further be aligned with a respective opening 172. During use, light (indicated at arrow 204) for each for each light source or LED 202 may thus pass from the LED 202, through a light pass-through hole 196, and then out of the panel lip 162 through a respective opening 172.

Turning now to FIG. 5, a flow diagram is provided of method 500, according to an example embodiment of the present disclosure. Generally, the method 500 provides a method operating a cooking appliance 100. Specifically, method 500 provides for controlling illumination of a cooking appliance 100 (e.g., as a lighting task). As described above, the cooking appliance 100 may include a cabinet 110, a user interface panel 154 mounted to the cabinet 110, and a lighting device 200 positioned on the cabinet housing above the user interface panel 154. The method 500 can be performed, for instance, by the controller 127. For example, controller 127 may, as discussed, be in communication with lighting device 200. Moreover, controller 127 may send signals to and receive signals from lighting device 200 and/or sensor 210. Controller 127 may further be in communication with other suitable components of the appliance 100 to facilitate operation of the appliance 100, generally. FIG. 5 depicts steps performed in a particular order for purpose of illustration and discussion. Those of ordinary skill in the art, using the disclosures provided herein, will understand that the steps of any of the methods disclosed herein can be modified, adapted, rearranged, omitted, or expanded in various ways without deviating from the scope of the present disclosure, except as otherwise indicated.

At 510, the method 500 includes receiving a provisional lighting command. For example, a user may provide an input or selection at the user interface of the appliance. The provisional lighting command may be provided as general setting or mode of operation that allows for permissive or selective operation of the lighting device. In some embodiments, the provisional lighting command may be received by the controller in response to engagement of a mechanical user input (e.g., button or switch) on a front panel of the appliance. In alternative embodiments, the provisional lighting command may be received by the controller in response to selection made through a non-mechanical input. If the user interface panel includes a graphical display having a touch screen, the provisional lighting command may be included within an optional mode that may be selected by a capacitive “button” or within a graphical menu of the user interface panel. In turn, a mechanical switch may not be necessary.

At 520, the method 500 includes determining an activation condition for the lighting device. The activation condition may be secondary to the provisional lighting command. In some embodiments, the step 520 may thus be required to occur subsequent to the controller receiving the provisional lighting command at step 510.

Generally, one or more activation conditions may be provided as suitable preset actions or states for the use of light from the lighting device. As an example, the activation condition (e.g., one activation condition) may be a specific activation time, e.g., a selected uniform standard time or isolated time period. In some such embodiments, step 520 includes receiving a time signal (e.g., at the controller) from a clock module according to the activation time signal. As another example, the activation condition (e.g., one activation condition) may be an ignition (or attempted ignition) of a burner, e.g., a cooktop burner of the appliance. In some such embodiments, the activation condition (e.g., one activation condition) is determined from receipt of a burner signal, such as a signal corresponding to rotation of a burner knob on the user interface panel or to a detected flame ignition at the burner. In turn, step 520 may include determining the activation condition (e.g., at the controller) in response to an ignition of the cooktop burner. As yet another example, the activation condition may be a certain ambient light condition. Step 520 may include receiving an ambient light signal from an ambient light sensor mounted to the cabinet housing in operable communication with the user interface panel.

Although several activation condition examples are provided herein, it is understood that other suitable activation conditions may be provided in additional or alternative embodiments. Moreover, it is understood that some embodiments include a single activation condition, while other embodiments include multiple activation conditions (e.g., stored within the controller). If multiple activation conditions are provided, each activation condition may be codependent or independent on the other activation conditions.

At 530, the method 500 includes activating the lighting device in response to the determination of the activation condition (e.g., at step 520). A light source of the lighting device may be energized as a result of steps 520 and 510. In turn, the method 500 may generally function similar to an “if then that” sequence. Additionally or alternatively, the light source may be deactivated (e.g., such that light source is no longer energized) once the activation condition ends. A new determination may be made that the activation condition has ceased or expired. For example, the ambient light condition signal may end. As another example, a discrete deactivation signal may be received (e.g., from a time module upon the expiration of a preset active time following transmission of a first time signal).

If multiple light sources (i.e., a plurality thereof) are provided for the lighting device, step 530 may include energizing at least a portion of the plurality of the light sources according to a predetermined pattern. For example, all of the light sources may be energized simultaneously. Alternatively, each light source may be energized in a non-simultaneous pattern, e.g., in a sequential and/or repeating pattern. If a predetermined pattern is provided, step 530 may include energizing the lighting device or light source(s) according to the predetermined repeating pattern (e.g., in a strobe pattern, such that lighting device flashes or illuminates an area at a set interval or rate). Optionally, the predetermined pattern may include one or more colors (e.g., white, red, green, etc.) emanating from the lighting device.

In some embodiments, multiple visually-distinct predetermined patterns for the lighting device are provided for method 500, e.g., within the controller. Each visually-distinct predetermined pattern may correspond to a different condition. For example, a first activation condition and a second activation condition may be provided. The first activation condition may correspond to a first predetermined pattern for the lighting device while the second activation condition corresponds to a second predetermined pattern that is different from the first predetermined pattern. If a first activation condition is determined, method 500 may include determining a second activation condition. In response to the second activation condition (e.g., a determination of the second activation condition), the lighting device may be adjusted. In other words, the lighting device may be energized according to a second predetermined pattern (e.g., a predetermined repeating pattern).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A method of operating a cooking appliance, the cooking appliance comprising a cabinet housing, an interface panel mounted to the cabinet housing, and a lighting device positioned on the cabinet housing above the interface panel, the lighting device being directed to the interface panel, the method comprising:
receiving a provisional lighting command;
determining an activation condition subsequent to receiving the provisional lighting command; and
activating the lighting device in response to a combination of the determination of the activation condition and receiving the provisional lighting command prior to the determined activation condition,
wherein determining the activation condition comprises receiving a burner signal in response to a detected flame ignition at a burner of the cooking appliance.

2. (canceled)

3. (canceled)

4. (canceled)

5. (canceled)

6. (canceled)

7. The method of claim 1, wherein the activation condition is a first activation condition, and wherein the method further comprises:
determining a second activation condition; and
adjusting activation of the lighting device in response to the determination of the second activation condition.

8. The method of claim 7, wherein activating the lighting device comprises energizing the lighting device according to a first predetermined pattern, and wherein adjusting activation comprises energizing the lighting device according to a second predetermined pattern, the second predetermined pattern being visually distinct from the first predetermined pattern.

9. The method of claim 1, wherein the lighting device comprises a plurality of light sources, and wherein activating the lighting device comprises energizing the plurality of light sources simultaneously above the interface panel.

10. A cooking appliance comprising:
a cabinet housing;
an interface panel mounted to the cabinet housing, comprising a user input;
a lighting device positioned on the cabinet housing above the interface panel, the lighting device being directed toward the user inputs;
a cooktop burner positioned on the cabinet housing; and
a controller attached to the cabinet housing in operable communication with the lighting device, the controller being configured to energize the lighting device according to a lighting task, the lighting task comprising
receiving a provisional lighting command,
determining an activation condition subsequent to receiving the provisional lighting command, and
activating the lighting device in response to a combination of the determination of the activation condition and receiving the provisional lighting command prior to the determined activation condition,
wherein determining the activation condition comprises receiving a burner signal in response to a detected flame ignition at the cooktop burner.

11. (canceled)

12. (canceled)

13. (canceled)

14. (canceled)

15. The cooking appliance of claim 10, wherein activating the lighting device comprises energizing the lighting device according to a predetermined repeating pattern.

16. The cooking appliance of claim 10, wherein the activation condition is a first activation condition, and wherein the lighting task further comprises
determining a second activation condition, and
adjusting activation of the lighting device in response to the determination of the second activation condition.

17. The cooking appliance of claim 16, wherein activating the lighting device comprises energizing the lighting device according to a first predetermined pattern, and wherein adjusting activation comprises energizing the lighting device according to a second predetermined pattern, the second predetermined pattern being visually distinct from the first predetermined pattern.

18. The cooking appliance of claim 10, wherein the lighting device comprises a plurality of light sources, and wherein activating the lighting device comprises energizing the plurality of light sources simultaneously above the interface panel.

19. A method of operating a cooking appliance, the cooking appliance comprising a cabinet housing, an interface panel mounted to the cabinet housing, and a lighting device positioned on the cabinet housing above the interface panel, the lighting device being directed to the interface panel, the method comprising:
receiving a provisional lighting command from the interface panel;
determining an activation condition subsequent to receiving the provisional lighting command, the activation condition being independent from the provisional lighting command; and
activating the lighting device in response to a combination of the determination of the activation condition and receiving the provisional lighting command prior to the determined activation condition,
wherein determining the activation condition comprises receiving a lighting signal from an auxiliary control device in operable communication with the interface panel.

20. The method of claim 8, wherein determining the second activation condition comprises receiving a time signal from a clock module according to a predetermined activation time.

21. The method of claim 8, wherein determining the second activation condition comprises receiving a lighting signal from an auxiliary control device in operable communication with the interface panel.

22. The method of claim 8, wherein determining the second activation condition comprises receiving an ambient light signal from an ambient light sensor mounted to the cabinet housing in operable communication with the interface panel.

21. The cooking appliance of claim 17, wherein the controller comprises a clock module configured to transmit an activation time signal, and wherein determining the second activation condition comprises receiving a time signal from the clock module according to the activation time signal.

22. The cooking appliance of claim 17, further comprising an auxiliary control device positioned apart from the cabinet housing in operable communication with the controller, wherein determining the second activation condition comprises receiving a lighting signal from an auxiliary control device in operable communication with the interface panel.

23. The cooking appliance of claim 17, further comprising an ambient light sensor mounted to the cabinet housing in operable communication with the controller, wherein determining the second activation condition comprises receiving an ambient light signal from the ambient light sensor.
